(19) United States
(12) Patent Application Publication
(10) Pub. No.: US 2003/0033190 A1
(43) Pub. Date: Feb. 13, 2003

(54) On-line shopping conversion simulation module

(76) Inventors: Jerold Shan, Palo Alto, CA (US); Dirk Beyer, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/852,611

(22) Filed: May 9, 2001

(51) Int. Cl. G06F 17/60

(52) U.S. Cl. 705/10; 705/14

(57) ABSTRACT

A method for predicting whether an on-line shopper is converted into becoming a purchaser of an item based on promotions offered by an on-line vendor. A set of data including customer profile information corresponding to a plurality of on-line shoppers; customer log information corresponding to the plurality of on-line shoppers; product information corresponding to a plurality of products offered for sale by the on-line vendor; and promotion attributes corresponding to the plurality of products are stored in a database. Next, a model which simulates shopping behavior as a function of the customer profile information, customer log information, product information, and promotion attributes is constructed. This model is partially based on the traditional logistical regression theory and partially on the maximum utility theories. Thereby, the data corresponding to a new on-line shopper is input to the model which then compute a percentage likelihood that the shopper is converted into becoming a purchaser.

### TECHNICAL FIELD

The present invention relates to the field of modeling and simulations. More specifically, the present invention pertains to an apparatus and method for modeling and simulating the conversion beviour of on-line shoppers.

### BACKGROUND ART

With the advent of the Internet, people can log on and shop on-line from the convenience of their home. Rather than physically driving to a store, hunting for merchandise, waiting in line to purchase the item, lugging bags around, and then driving back home, the Internet now enables shoppers to simply browse the websites of any one of a multitude of on-line retailers offering products for sale to the public. Consumers can browse the web pages of different on-line retailers to find the particular products they desire, shop for best price, determine the availability and features of the items of interest, and ultimately pay with a credit card.

The on-line shopping experience is enjoying great popularity due to the ease and convenience by which people can access web sites and peruse the merchandise being offered. However, in order to be successful, the on-line retailer must convert the browsing public into active purchasers. Not only are on-line retailers faced with the task of getting potential shoppers to click on and visit their website, but the on-line retailers must then efficiently convert these would-be shoppers into buying their merchandise.

On-line retailers have several mechanisms by which they can entice browsers into actually buying their products. For instance, on-line retailers can offer promotions such as sales, buy-one-get-one-free, donating a portion of the sale to a customer's favorite charity, extended warranties, frequent-buyer programs, upgrades, financing packages, etc. However, the more promotions lavished into converting potential customers directly cuts into the retailer's profits. There must be some balance between the degree of promotions and the chance of converting a shopper into a buyer.

One way in which to determine this delicate balance entails modeling the shopping behavior of on-line shoppers. In theory, the model would reliably predict the percent chance of converting an on-line shopper given a selected set of promotions. By using such a model, on-line retailers could adjust their promotions to maximize profits while minimizing the costs associated promotional costs. Moreover, on-line retailers could use this model to customize their web offerings and even offer specific sets of promotions tailored to individual potential customers visiting their sites. Indeed, intelligent software could use the model to automatically customize promotions to a particular visitor's known preferences, past history, demographics, ethnicity, etc.

Thus, there exists a need for an accurate model for forecasting a on-line shopper's behavior.

### DISCLOSURE OF THE INVENTION

The present invention relates to an on-line shopping conversion simulation module. This on-line shopping conversion simulation module is used for predicting the chance of an on-line shopper being converted into becoming an actual purchaser of an item based on promotions offered by an on-line vendor. Sets of data including on-line customers' profile information; customer log information; product information corresponding to a plurality of products offered for sale by the on-line vendor; and promotion attributes corresponding to the plurality of products are stored in a database. Next, a model which simulates shopping behavior as a function of the customer profile information, customer log information, product information, and promotion attributes is constructed. This model is partially based on the traditional logistical regression theory and partially on the maximum utility theories. Thereby, the data corresponding to a new on-line shopper is input to the model which then compute a percentage likelihood that the shopper is converted into becoming a purchaser.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a block diagram of an on-line shopping conversion simulation module according to the currently preferred embodiment of the present invention.

FIG. 2 shows the processes related to the currently preferred embodiment of the on-line shopping conversion simulation module.

FIG. 3 shows a generic personal computer upon which the present invention may be practiced.

### BEST MODE FOR CARRYING OUT THE INNOVATION

An apparatus and method for an on-line shopping conversion simulation module is described. In the following detailed description of the present invention, numerous specific details are set forth in order to provide a thorough understanding of the present invention. However, it will be obvious to one skilled in the art that the present invention may be practiced without these specific details or by using alternate elements or methods. In other instances well known methods, procedures, components, and circuits have not been described in detail as not to unnecessarily obscure aspects of the present invention.

An on-line visitor to a shopping site may or may not be converted into a customer, that is, a visitor may or may not buy a promotion product. If the visitor does buy, the purchase quantity is also unknown to us beforehand.

The most critical element to the success for any on-line and off-line shopping site is a deep understanding of what factors are relevant to, and how they are correlated to the conversion process. To this end, the present invention of an on-line shopping conversion simulation module has been developed.

In the currently preferred embodiment, the on-line shopping conversion simulation module of the present invention comprises of two components. One is the simulator that the users can simulate the conversion process, including the conversion status, and if converted, the purchase quantity, cost and revenue. The other component is the modeling part, which hides behind the users, but is the core machine that addresses exactly the aforementioned issues regarding the shopping behavior of customers.

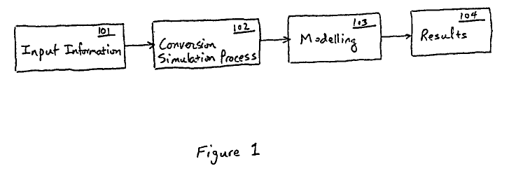

Referring to FIG. 1, data regarding shoppers is stored in a database 101.

This data is fed into the conversion simulation process 102. A modeling engine 103 is then used to generate the probability of converting a particular shopper into a purchaser. The resulting probability is displayed and stored as a percentage 104.

Essentially, the simulator 102 and model 103 relate a customer's profile information and a product promotions' effects to the customer's conversion probability. The modeling part, partially based on the traditional logistical regression theory, and partially on the maximum utility theories developed by Nobel Prize winner Daniel McFadden, addresses the question why customers do or do not get converted from a visitor's status to a customer's status. The simulation part simulates the conversion behavior based on the model. This module can greatly facilitate the development of other analytic CRM (Customer Relationship Management) components, and serve as testing bed of any analytic CRM systems, as demonstrated in the eMO (e-Market Optimization) development. For example, without this module, the optimization module in eMO simply won't have any opportunity to be tested and refined before any real world application.

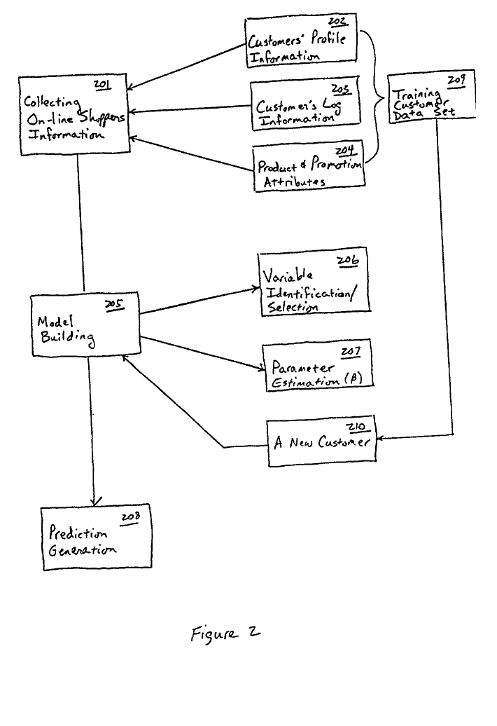

FIG. 2 shows the processes related to the currently preferred embodiment of the on-line shopping conversion simulation module. Initially, a database containing on-line shoppers information is created and maintained, 201. This on-line shoppers information includes information regarding the profiles of various customers, 202. The profile information contains extensive information regarding a particular shopper, such as the shopper's age, sex, religion, income, ethnicity, marital status, geographical location, number of children, interests, hobbies, spending habits, etc. Any information which may characterize a shopper is beneficial to be included in the customer profile information. Initially, these customer profiles can be purchased or accumulated and updated over time.

The on-line shoppers information also includes information relating to customers' web log information, 203. This log information contains data regarding when the customer accessed the web site, how long the customer visited the web site, which items were of interest, how the customer heard 110 about the web site, whether the customer saw the promotion(s), whether the customer was motivated to taking action as a result of the promotion(s), whether the customer inspected an item, whether the customer put the item back, whether the customer bought an item, the quantity of items purchased, etc. The log information basically contains a historical account of a shopper's actions from the moment the shopper first enters the web site to when that shopper leaves the web site. This information is collected and stored with each visitor to the vendor's web site.

The third set of data relating to the on-line shoppers information characterizes product and promotion attributes, 204. Each product is different from other products offered for sale on-line. As such, each product has its dedicated set of attributes. These attributes describe that particular item for sale and may include its price, color, make, model, manufacturer, size, weight, availability, features, functionalities, etc. Also included are promotions (if any) corresponding to each of the products offered for sale.

These promotions are used to entice shoppers to purchasing a particular item.

Promotions can include sales, upgrades, extended warranties, buy-one-get-one free, financing packages, free options, rebates, coupons, donations to charities, free gifts, etc. These product and promotion attributes are known and set by the on-line vendor. The vendor may selectively vary one or more of these promotion attributes, depending on a particular shopper, a particular item, or a combination thereof. The manner by which the promotion attributes are set may be a function of the results generated by the on-line shopping conversion simulator.

The next process involves building the on-line shopping conversion 110 model and simulator, 205. In the currently preferred embodiment, the model and the simulator relate a customer's profile information and an on-line product promotion's effects to the customer's conversion probability. The modeling part, partially based on the traditional logistical regression theory, and partially on the maximum utility theories developed by this year's Nobel Prize winner, Daniel McFadden, addresses the question of why customers do or do not get converted from a visitor's status to a customer's status. The simulation part simulates the conversion behavior based on the model. This module can greatly facilitate the development of other analytic CRM components, and serve as testing bed of any analytic CRM systems, as demonstrated in the eMO development. For example, without this module, the optimization module in eMO simply will not have any opportunity to be tested and refined before any real world application. As part of the model building, a list of variables relating to model need to be first identified and selected, step 206. Furthermore, one or more key parameters must be estimated, step 207.

Based on the model constructed in process 205, one can predict the likelihood that a particular shopper will be converted into a purchaser, 208. When a new customer visits the web site, the chances for converting the customer into a buyer is calculated according to the initial training customer data set, 209. The model created in 205 then generates the chances of conversion. The customer's actual log information is collected and this new information is retained and fed back as relevant information. Based on this new information, the variable identification and selection process can be refined. Furthermore, a better estimation of the parameter(s) can be calculated. Thereby, the model can be continuously updated and improved upon with each new actual customer information being input to the overall process.

In the currently preferred embodiment, the promotions and customer segments need to be defined. A promotion is defined as a set of attributes. For example, it can consist of the following: discount rate, free shipping & handling, rebate, special event promotional discount. For a customer segment, it is also defined as a set of attributes. For example, it can consist of the following: average time on site, purchased-on-line-before probability, product market saturation rate. Any individual customer from a segment is a stochastic realization from a model with the “mean value”, which is specified by the mean attributes. For each attribute, there can be multiple levels. The following is a sample specification of Promotion and Class (Segment). It is an input to the SIM1, the simulator function that is implemented in SPlus (a statistical computing language).

list(“Promotion”=list(“special.prod.disc.rate.all”=c(5., 20., 40.)

, “special.refsite.disc.rate.all”=c(5., 40.)

)

, “Class”=list(“seconds.on.site.lambda.all”=c(10., 60.,120.)

, “purchased.online.bf.p.all”=c(0.01, 0.4)

)

)

For a product, one can introduce the notion of a multi-attribute. The simulation can be expanded to include that generalized promotion definition.

Next, the simulation of a fixed combination of promotion and Segment is defined as a SIM1 function. For example:

SPlus>SIM1(N=1000., Customer.Group.ID=“C1”,

Promotion.ID=“P1”, Spec=Spec.sdat)

The SIM1 function simulates the on-line shopping activities, and the returned process value is to be used as a proxy for real on-line shopping data. There are many underlying patterns or customer behaviors that can be built based on econometric modeling experiences. Suppose a customer visits a shopping site. There are many products advertised on the site. For any single product, with the on line sales price information, and customer's knowledge, the customer can deduce the DiscountPercentageToOffline. The customer will then decide if he or she will get a good offer based on the utilities derived from all the information. The customer may or may not see the ad, and may or may not select the product, and may or may not finally buy it. For each corresponding step, a (conditional) logistic regression model is used to generate the process. The choice of logistic regression model is based on the maximum utility theory developed in the demand model. For example, one can model:

$$P ( Buy = 1 \vert Select = 1 ) = \frac{exp ( {β}^{′} X )}{1 + {exp ( {β}^{′} X )}^{′}}$$

where X is a vector of vector: X=(X₁;X₂;X₃), X₁ is the customer profile information vector, X₂ is the promotion attribute vector, and X₃ is the product attribute vector. The following distributional property has been used: If X₁˜B(1; P₁); X2˜B(1; P₂₁), independently distributed, then Y=X₁X₂˜B(1; P₂) where P2=P₁P₂₁.

If the customer buys a product, the customer may buy more than one item. For the quantity sold, it is modeled to be statistically “proportional” to the discount effect. Specifically, the value takes a Poisson distribution, with the distribution mean proportional to the discount effect. However, there is upper limit for the purposes of inventory safety and of customer attraction distribution. In the currently preferred embodiment, a truncated Poisson Distribution is used so that the returned value is at least 1 and no greater than K. It should be noted that there is a holiday effect on people's buying behavior. Some holidays produce a positive effect, such as in Christmas, and some produce a negative effect, such as spring break or summer hot days.

The Wealth Effect Index: zip+4 code and house/apt ownership indication on shipping address. From the zip code, one can get the average house information: average income, average house member number. One can also can get a relationship between income and house ownership. The Zip code could also provide market saturation rate, which should also be a factor in the conversion model. In this particular implementation, customer class (characteristics, a multi-attribute vector) variables are created and controlled (so that one can have a perfect segmentation):

1. seconds.on.site.lambda

2. purchased.online.before.probability

Also, the promotion variables are created that are used to control:

1. special.prod.disc.rate

2. special.refsite.disc.rate

The following is an example of the output from SIM1. SPlus>SIM1(5)

| | Promotion.ID | Customer.Group.ID | Product.ID | Ad.On.Days | Holiday.Eff |
|---|---|---|---|---|---|
| 1 | P1 | C1 | D6 | 24 | 0 |
| 2 | P1 | C1 | D7 | 41 | 0 |
| 3 | P1 | C1 | D10 | 33 | 0 |
| 4 | P1 | C1 | D4 | 25 | 0 |
| 5 | P1 | C1 | D2 | 34 | 0 |

| | Discount.Percentage | Seconds.On.Site | Refsite.URL | ZipCode |
|---|---|---|---|---|
| 1 | 6 | 11 | hr.org | 70151 |
| 2 | 6 | 10 | hd.com | 30164 |
| 3 | 7 | 13 | tk.com | 20177 |
| 4 | 2 | 11 | zv.com | 30180 |
| 5 | 1 | 13 | qg.com | 70103 |

| | House. | | | |
|---|---|---|---|---|
| | Ownership.Indicator | Purchased.Online.Bf | Did.See | Did.Select |
| 1 | 1 | 0 | 1 | 0 |
| 2 | 0 | 0 | 1 | 1 |
| 3 | 1 | 0 | 1 | 1 |
| 4 | 0 | 0 | 1 | 1 |
| 5 | 0 | 0 | 1 | 1 |

| | Conversion.Prob | Did.Buy | Bought.Qty | Revenue | Discount.Loss | Matl.Cost |
|---|---|---|---|---|---|---|
| 1 | 0.3371550 | 0 | 0 | 0.00 | 0.0000 | 0 |
| 2 | 0.3338475 | 1 | 3 | 1979.35 | 120.6462 | 1700 |
| 3 | 0.3665212 | 0 | 0 | 0.00 | 0.0000 | 0 |
| 4 | 0.2784663 | 0 | 0 | 0.00 | 0.0000 | 0 |
| 5 | 0.2800296 | 0 | 0 | 0.00 | 0.0000 | 0 |

| | Fixed.Cost | Profit.a | Profit.b |
|---|---|---|---|
| 1 | 0 | 0.00 | 0.00 |
| 2 | 0 | 279.35 | 158.71 |
| 3 | 0 | 0.00 | 0.00 |
| 4 | 0 | 0.00 | 0.00 |
| 5 | 0 | 0.00 | 0.00 |

The on-line shopping conversion simulation module can also perform a simulation of several combinations of promotions and segments. Based on SIM1, SIM2 can simulate for (arbitrarily) several combinations of promotions and segments. For example:

SPlus>SIM2(N=1., data.dir=“Testing0809”, Spec.file=“Spec.list”)

It should be noted that this is a full factorial design, which has no problem in affording in the simulation world. However, in the real world, for any single test of each combination, the cost is usually quite significant. Consequently, one has to consider the fractional factorial design. The output from SIM2 is similar to that from SIMI, except the output results are from the selected combinations of the controllable variables.

With the output from this all combination simulation, the data is sent for the optimization engine to optimize over the space of segment and promotion, using different objective functions. Out of the OPT (Optimization program) are the optimization plans that are evaluated in the next step. The following example plan was derived from OPT, with the objective function being the conversion rate, and using the estimated conversion rate from the training data set:

convest

P|6|C1|1.00

P6|C2|1.00

P6|C3|1.00

P6|C4|1.00

P6|C5|1.00

P6|C6|1.00

Using simple statistical analysis, statistically-driven” optimal plans can be derived, which are then used to compare with and test the OPT derived plans. Specifically, for each combination of promotion and segment (Pi; Cj), the average value of “performance metrics”, including the conversion rate, cost, revenue, and profit are computed. Then for any given objective function, for example, the conversion rate, the first six combinations that have the largest values are selected. The reason to use six combinations is to maintain the same total customer base, since for all combination, one would allocate to the same number of customers. The following is a sample comparison report.

SPlus>Eval.s(N=2000, data.dir=“Testing0801”)

| | Conversion.Rate | Gross.Rev | Discount.Loss | Matl.Cost | Rev | Profit |
|---|---|---|---|---|---|---|
| convest | 0.4233 | 313.8 | 216.7 | 432.9 | −119.0 | −335.7 |
| convrdm | 0.3992 | 373.7 | 116.5 | 400.1 | −26.5 | −143.0 |
| convrdm01 | 0.3692 | 369.9 | 72.6 | 361.4 | 8.5 | −64.2 |
| convrdm90 | 0.4067 | 349.4 | 136.8 | 397.1 | −47.7 | −184.5 |
| gpest | 0.3550 | 386.8 | 35.2 | 344.7 | 42.1 | 7.0 |
| gprdm | 0.3550 | 386.8 | 35.2 | 344.7 | 42.1 | 7.0 |
| gprdm01 | 0.3550 | 386.8 | 35.2 | 344.7 | 42.1 | 7.0 |
| gprdm90 | 0.3550 | 386.8 | 35.2 | 344.7 | 42.1 | 7.0 |
| revest | 0.4058 | 394.0 | 104.3 | 406.8 | −12.8 | −117.1 |
| revrdm | 0.3992 | 373.7 | 116.5 | 400.1 | −26.5 | −143.0 |
| revrdm01 | 0.3758 | 360.9 | 81.5 | 361.4 | −0.6 | −82.1 |
| revrdm90 | 0.4108 | 390.6 | 112.5 | 410.8 | −20.1 | −132.7 |

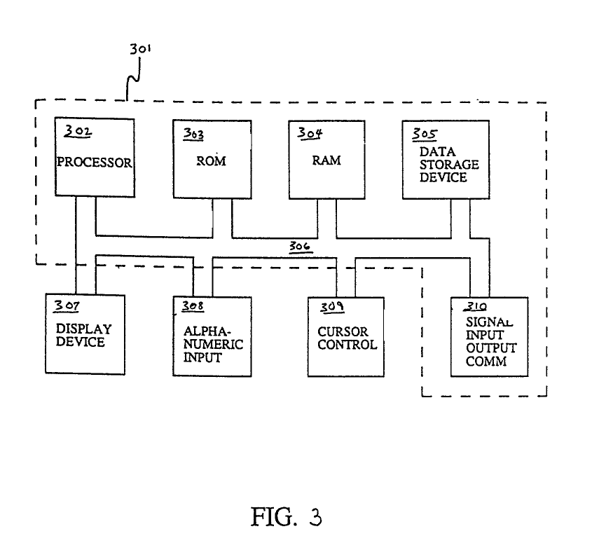

FIG. 3 shows a generic personal computer upon which the present invention may be practiced. Computer system 301 of FIG. 3 includes an address/data bus 306 for communicating information, a central processor 302 unit coupled with the bus 306 for processing information and instructions, a random access memory 304 coupled with the bus 306 for storing information and instructions for the central processor 302, a read only memory 303 coupled with the bus 306 for storing static information and instructions for the processor 302, a data storage device 305 (e.g., a magnetic or optical disk and disk drive) coupled with the bus 306 for storing information and instructions, a display device 307 coupled to the bus 306 for displaying information to a computer user, an alphanumeric input device 308 including alphanumeric and function keys coupled to the bus 306 for communicating information and command selections to the central processor 302, a cursor control device 309 coupled to the bus for communicating user input information and command selections to the central processor 302, and a signal generating device 310 coupled to the bus 100 for communicating command selections to the processor 302. A copy of the on-line shopping conversion simulation module can be stored in data storage device 305. along with the relevant data. Processor 302 processes the information and generates a percentage conversion rate for on-line shoppers.

The preferred embodiment of the present invention, an on-line shopping conversion simulation module, is thus described. While the present invention has been described in particular embodiments, it should be appreciated that the present invention should not be construed as limited by such embodiments, but rather construed according to the below claims.

What is claimed is:

1. A method for predicting whether an on-line shopper is converted into becoming a purchaser of an item based on promotions offered by an on-line vendor, comprising the steps of:
storing customer profile information corresponding to a plurality of on-line shoppers;
storing customer log information corresponding to the plurality of on-line shoppers;
storing product information corresponding to a plurality of products offered for sale by the on-line vendor
storing promotion attributes corresponding to the plurality of products;
constructing a model which simulates shopping behavior as a function of the customer profile information, customer log information, product information, and promotion attributes;
generating a percentage chance that the customer purchases a particular item based on the model;
displaying the percentage chance.

2. The method of claim 1 further comprising the steps of:
identifying relevant variables;
selecting a plurality of relevant variables in constructing the model.

3. The method of claim 2 further comprising the step of estimating a parameter for use in constructing the model.

4. The method of claim 1, wherein the model comprises a logistic regression model.

5. The method of claim 4, wherein the logistic regression model comprises:
$$P ( Buy = 1 \vert Select = 1 ) = \frac{exp ( {β}^{′} X )}{1 + {exp ( {β}^{′} X )}^{′}} .$$

6. The method of claim 4, wherein the model is partially based on traditional logistical regression theory and partially on the maximum utility theory.

7. The method of claim 1, wherein customer profile information includes age, sex, religion, income, ethnicity, marital status, geographical location, number of children, interests, hobbies, spending habits, and zip code.

8. The method of claim 1, wherein the customer log information includes contains data regarding when the customer accessed the web site, how long the customer visited the web site, which items were of interest, how the customer heard about the web site, whether the customer saw the promotion, whether the customer was motivated to taking action as a result of the promotion, whether the customer inspected an item, whether the customer put the item back, whether the customer bought an item, and the quantity of items purchased.

9. The method of claim 1, wherein the promotion attributes include one of sales, upgrades, extended warranties, buy-one-get-one free, financing packages, free options, rebates, coupons, donations to charities, and free gifts.

10. A computer-readable medium having stored thereon instructions for predicting whether an on-line shopper is converted into becoming a purchaser of an item based on promotions offered by an on-line vendor, the instructions comprising the steps of:
storing customer profile information corresponding to a plurality of on-line shoppers;
storing customer log information corresponding to the plurality of on-line shoppers;
storing product information corresponding to a plurality of products offered for sale by the on-line vendor storing promotion attributes corresponding to the plurality of products;
constructing a model which simulates shopping behavior as a function of the customer profile information, customer log information, product information, and promotion attributes;
generating a percentage chance that the customer purchases a particular item based on the model;
displaying the percentage chance.

11. The computer-readable medium of claim 10, wherein the instructions further comprise the steps of:
identifying relevant variables;
selecting a plurality of relevant variables in constructing the model.

12. The computer-readable medium of claim 10, wherein the instructions further comprise the step of estimating a parameter for use in constructing the model.

13. The computer-readable medium of claim 10, wherein the model comprises a logistic regression model.

14. The computer-readable medium of claim 13, wherein the logistic regression model comprises:
$$P ( Buy = 1 \vert Select = 1 ) = \frac{exp ( {β}^{′} X )}{1 + {exp ( {β}^{′} X )}^{′}} .$$

15. The computer-readable medium of claim 14, wherein the model is partially based on traditional logistical regression theory and partially on the maximum utility theory.

16. The computer-readable medium of claim 10, wherein customer profile information includes age, sex, religion, income, ethnicity, marital status, geographical location, number of children, interests, hobbies, spending habits, and zip code.

17. The computer-readable medium of claim 10, wherein the customer log information includes contains data regarding when the customer accessed the web site, how long the customer visited the web site, which items were of interest, how the customer heard about the web site, whether the customer saw the promotion, whether the customer was motivated to taking action as a result of the promotion, whether the customer inspected an item, whether the customer put the item back, whether the customer bought an item, and the quantity of items purchased.

18. The computer-readable medium of claim 10, wherein the promotion attributes include one of sales, upgrades, extended warranties, buy-one-get-one free, financing packages, free options, rebates, coupons, donations to charities, and free gifts.
